(19) United States
(12) Patent Application Publication
(10) Pub. No.: US 2023/0284302 A1
(43) Pub. Date: Sep. 7, 2023

(54) WIRELESS COMMUNICATION METHOD AND TERMINAL STATION APPARATUS

(71) Applicant: NIPPON TELEGRAPH AND TELEPHONE CORPORATION, Tokyo (JP)

(72) Inventors: Tatsuhiko IWAKUNI, Musashino-shi, Tokyo (JP); Daisei UCHIDA, Musashino-shi, Tokyo (JP); Chunhsiang HUANG, Musashino-shi, Tokyo (JP); Shuki WAI, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 18/018,011

(22) PCT Filed: Jul. 29, 2020
(86) PCT No.: PCT/JP2020/028983

§ 371 Date: Jan. 25, 2023

(51) Int. Cl. H04W 76/15

(52) U.S. Cl. CPC H04W 76/15

(57) ABSTRACT

A radio communication method performed by a terminal station device includes: a first radio communication step of establishing connection to a first base station device among a plurality of surrounding base station devices; a control step of recording information regarding the first base station device on a storage unit as first connection destination information; and a second radio communication step of establishing connection to a second base station device different from the first base station device with regard to the first connection destination information among the plurality of base station devices.

### TECHNICAL FIELD

The present invention relates to a radio communication method and a terminal station device.

### BACKGROUND ART

In radio communication in which a high frequency band such as a millimeter wave band is used, a wideband can be guaranteed, compared to radio communication using a microwave band. As a radio communication scheme using a high frequency band, for example, there is IEEE 802.11ad. Radio communication in which a high frequency band is used has advantages of high linearity of a radio signal in a propagation path and little interference with other radio communication. Therefore, a study for widely using radio communication in which a high frequency band is used has been carried out (see NPL 1).

A distance attenuation amount of a radio signal in a propagation path increases according to the frequency of the radio signal. A radio signal in radio communication such as IEEE 802.11ad in which a 60 GHz band is used is easily absorbed by oxygen in a propagation path. For this reason, in radio communication in which a high frequency band such as a millimeter wave band is used, a base station device forms a directional beam (performs beamforming) toward a terminal station device which is a communication partner and transmits a radio signal toward the terminal station device. The base station device performs beamforming toward the terminal station device and receives a radio signal from the terminal station device. Similarly, the terminal station device may also perform beamforming toward the base station device and receive a radio signal from the base station device. The terminal station device may perform beamforming toward the base station device and transmit a radio signal toward the base station device (see NPL 2).

### CITATION LIST

### Non Patent Literature

[NPL 1] Takinami and three others “Standardization Trend and Elemental Technology for Millimeter Wave Band Wireless LAN System,” IEICE Communication Society Magazine, No. 38, Autumn 2016, pp.100 to 106.

[NPL 2] IEEE, “Part 11: Wireless LAN Medium Access Control (MAC) and Physical Layer (PHY) Specifications, Amendment 3: Enhancement for Very High Throughput in the 60 GHz Band” (IEEE Std 802.11ad-2012), 2012/12/28

### SUMMARY OF INVENTION

### Technical Problem

FIG. 25 is a diagram illustrating an example of a communication link of a radio communication system using beamforming of a millimeter wave band. When a radio signal is transmitted from a base station device 100 to a terminal station device 200, the base station device 100 installed on the ground selects a directional beam of which reception power is the maximum in the terminal station device 200 from directional beams which can be formed by the base station device 100. The moving terminal station device 200 also selects a directional beam with the maximum reception power of the radio signal from the directional beams which can be formed by the terminal station device 200.

In FIG. 25, the base station device 100 forms a directional beam 400 and the terminal station device 200 forms a directional beam 500. In this way, a communication link 600 using the directional beams 400 and 500 is formed.

When radio communication in which beamforming with a millimeter wave band is used is applied to a mobile communication system, it is necessary that the base station device 100 and the terminal station device 200 adaptively switch directional beams in accordance with the movement of the terminal station device 200 and a change in a nearby propagation path, and cause the directional beams to follow the movement of the terminal station device 200 and the change in the nearby propagation path. In particular, when a change in a propagation path in which a propagation path used by the communication link 600 is blocked occurs, the reception power of the radio signal may suddenly drop, the communication link 600 may be disconnected, and communication between a high-order network device (not illustrated) of the base station device 100 and the terminal station device 130 may be disconnected.

Therefore, to avoid the communication disconnection, a plurality of radio communication units 300 may be included in the terminal station device 200. By connecting the plurality of radio communication units 300 to different base station devices 100, redundancy of a communication link can be achieved.

FIG. 26 is a diagram illustrating an example of a redundant communication link. The terminal station device 130 includes two radio communication units. In FIG. 26, the two radio communication units are a radio communication unit 140 and a radio communication unit 150. The radio communication unit 140 forms a communication link 160 with the base station device 110. The radio communication unit 150 forms a communication link 170 with the base station device 120. For example, even when an obstruction enters a propagation path of a radio signal of the communication link 160 and the communication link 160 is disconnected, the communication link 170 is maintained. Therefore, connection between a high-order network device (not illustrated) of the base station device 120 and the terminal station device 130 is maintained.

However, a configuration of the redundant communication link is applied to an autonomous distributed type radio communication system such as “IEEE 802.11ad,” redundancy effects may not be sufficiently obtained in some cases. In the autonomous distributed type radio communication system, each radio communication unit performs connection control independently based on a communication quality index such as a received signal strength indicator (RSSI) measured by each radio communication unit. When there is a bias in RSSI for each base station device (for example, when terminal station devices are located near the same base station device), a plurality of radio communication units are connected to the same base station device. Therefore, the redundancy effects may not be sufficiently obtained.

FIG. 27 is a diagram illustrating an example of a communication link of a radio communication system when the terminal station device 130 is located near the base station device 110. In FIG. 27, RSSI measured by the radio communication unit 140 with regard to the base station device 110 is greater than RSSI measured by the radio communication unit 140 with regard to the base station device 120. Similarly, RSSI measured by the radio communication unit 150 with regard to the base station device 110 is greater than RSSI measured by the radio communication unit 150 with regard to the base station device 120.

Therefore, both the radio communication unit 140 and the radio communication unit 150 may be connected to the base station device 110. In this case, a communication link 180 formed between the base station device 110 and the radio communication unit 150 is close to the communication link 160 formed between the base station device 110 and the radio communication unit 140. In this case, the communication link 160 and the communication link 180 are blocked and disconnected simultaneously, and thus there is a high possibility of communication between the terminal station device 130 and the high-order network device (not illustrated) being disconnected. In the related art, even when a plurality of radio communication units are included in the terminal station device 130 to realize the configuration of a redundant communication link, the redundancy effects may not be sufficiently obtained.

There is also a similar problem in a centralized control type radio communication system such as 5th Generation (5G) in the 3rd Generation Partnership Project (3GPP). In a centralized control type communication scheme, at the time of initial connection, the terminal station device independently retrieves information regarding base station devices which are around the own terminal station device. The terminal station device selects and determines a base station device that will be a connection destination. Therefore, even when the terminal station device includes a plurality of radio communication units, the plurality of radio communication units are connected to the same base station device. Therefore, the redundancy effects may not be sufficiently obtained.

In the centralized control type radio communication system, handover control in response to movement of the terminal station device and a change in a propagation path near the terminal station device differs from handover control in the autonomous distributed type radio communication system.

FIG. 28 is a sequence diagram illustrating an operation example of handover control. A radio communication unit included in the terminal station device acquires an instruction to measure a surrounding environment (hereinafter referred to as “surrounding environment measurement instruction”) from a high-order network device (not illustrated) connected to the base station device. The radio communication unit measures information regarding base station devices or the like around the terminal station device as a surrounding environment in response to the surrounding environment measurement instruction. The radio communication unit transmits information regarding the surrounding environment to the high-order network device (not illustrated) in the format of, for example, a measurement result report.

The high-order network device selects a base station device that will be a connection destination of the radio communication unit based on the measurement result report or the like transmitted from the radio communication unit. The high-order network device gives an instruction of the base station device that will be a connection destination to the radio communication unit based on a selection result. In his way, in the centralized control type radio communication system, the terminal station device does not select the connection destination of the radio communication unit, but the high-order network device selects the connection destination of the radio communication unit.

Accordingly, when a plurality of radio communication units provided in the same terminal station device independently transmit measurement result reports, there is a high possibility of the high-order network device selecting the same base station device to which the plurality of radio communication units are connected.

To avoid the connection of the plurality of radio communication units to the same base station device, the high-order network device may include a functional unit that determines whether the plurality of radio communication units are connected to the same terminal station device. However, since overhead of signals for reporting whether the plurality of radio communication units are connected to the same terminal station device, processing cost of necessary for the determination, and mounting cost of the processing necessary for the determination are required, it is desirable to obtain the redundancy effects with a simpler configuration.

In this way, in the related art, when a terminal station device including a plurality of radio communication units corresponding to the same communication standard performs connection control, the plurality of radio communication units may be connected to the same base station device. Here, since a plurality of mutually close communication links are susceptible to an influence of the same obstruction or the like, stability of communication cannot be improved in some cases.

In view of such circumstances, an objective of the present invention is to provide a radio communication method and a terminal station device capable of improving stability of communication.

### Solution to Problem

According to an aspect of the present invention, there is provided a radio communication method performed by a terminal station device. The method includes: a first radio communication step of establishing connection to a first base station device among a plurality of surrounding base station devices; a control step of recording information regarding the first base station device on a storage unit as first connection destination information; and a second radio communication step of establishing connection to a second base station device different from the first base station device with regard to the first connection destination information among the plurality of base station devices.

According to another aspect of the present invention, there is provided a radio communication method performed by a terminal station device. The method includes: a first radio communication step of establishing connection to a first connection destination which is a first base station device among a plurality of surrounding base station devices; a second radio communication step of establishing connection to a second connection destination which is the first base station device or a second base station device among the plurality of base station devices; and a control step of determining whether the first connection destination is identical to the second connection destination, and changing the second connection destination to the second base station device when the first connection destination is determined to be identical to the second connection destination.

According to still another aspect of the present invention, there is provided a radio communication method performed by a terminal station device. The method includes: a first radio communication step of establishing connection to a first base station device among a plurality of surrounding base station devices; a control step of recording information regarding the first base station device on a storage unit as first connection destination information; and a second radio communication step of measuring communication quality of each base station device with respect to the plurality of base station devices, and transmitting information regarding the communication quality of each base station device other than the first base station device with regard to the first connection destination information to a high-order network device that performs handover control based on the information regarding the communication quality of each base station device.

According to still another aspect of the present invention, a terminal station device includes: a first radio communication unit connected to a first base station device among a plurality of surrounding base station devices; a control unit configured to record information regarding the first base station device on a storage unit as first connection destination information; and a second radio communication unit connected to a second base station device different from the first base station device with regard to the first connection destination information among the plurality of base station devices.

According to still another aspect of the present invention, a terminal station device includes: a first radio communication unit connected to a first connection destination which is a first base station device among a plurality of surrounding base station devices; a second radio communication unit connected to a second connection destination which is the first base station device or a second base station device among the plurality of base station devices; and a control unit configured to determine whether the first connection destination is identical to the second connection destination, and change the second connection destination to the second base station device when the first connection destination is determined to be identical to the second connection destination.

According to still another aspect of the present invention, a terminal station device includes: a first radio communication unit configured to establish connection to a first base station device among a plurality of surrounding base station devices; a control unit configured to record information regarding the first base station device on a storage unit as first connection destination information; and a second radio communication unit configured to measure communication quality of each base station device with respect to the plurality of base station devices, and transmit information regarding the communication quality of each base station device other than the first base station device with regard to the first connection destination information to a high-order network device that performs handover control based on the information regarding the communication quality of each base station device.

### Advantageous Effects of Invention

According to the present invention, it is possible to improve stability of communication.

### BRIEF DESCRIPTION OF DRAWINGS

FIG. 1 is a diagram illustrating an example of a configuration of a radio communication system according to a first embodiment.

FIG. 2 is a diagram illustrating a first example of a state management table according to the first embodiment.

FIG. 3 is a flowchart illustrating an example of an operation of a control unit at the time of acquisition of a signal in the first embodiment.

FIG. 4 is a diagram illustrating a second example of the state management table according to the first embodiment.

FIG. 5 is a diagram illustrating a third example of the state management table according to the first embodiment.

FIG. 6 is a diagram illustrating a fourth example of the state management table according to the first embodiment.

FIG. 7 is a diagram illustrating a fifth example of the state management table according to the first embodiment.

FIG. 8 is a flowchart illustrating an example of an operation of a radio communication unit at the time of communication connection according to the first embodiment.

FIG. 9 is a flowchart illustrating an example of an operation of the radio communication unit at the time of communication disconnection according to the first embodiment.

FIG. 10 is a diagram illustrating a sixth example of the state management table according to the first embodiment.

FIG. 11 is a diagram illustrating a first example of a state management table according to a second embodiment.

FIG. 12 is a flowchart illustrating an example of an operation of a control unit at the time of acquisition of a signal according to the second embodiment.

FIG. 13 is a diagram illustrating a second example of the state management table according to the second embodiment

FIG. 14 is a flowchart illustrating an example of an operation of the control unit at the time of checking of the state management table according to the second embodiment. FIG. 15 is a diagram illustrating a third example of the state management table according to the second embodiment.

FIG. 16 is a flowchart illustrating an example of an operation of a radio communication unit at the time of communication connection according to the second embodiment.

FIG. 17 is a flowchart illustrating an example of an operation of the radio communication unit at the time of changing of a connection destination according to the second embodiment.

FIG. 18 is a diagram illustrating an example of a configuration of a radio communication system according to a third embodiment.

FIG. 19 is a diagram illustrating a first example of a state management table according to the third embodiment.

FIG. 20 is a flowchart illustrating an example of an operation of a control unit at the time of acquisition of a signal in the third embodiment.

FIG. 21 is a diagram illustrating a first example of a state management table according to the third embodiment.

FIG. 22 is a flowchart illustrating an example of an operation of a radio communication unit at the time of acquisition of a measurement instruction according to the third embodiment.

FIG. 23 is a flowchart illustrating an example of an operation of the radio communication unit at the time of acquisition of a handover instruction according to the third embodiment.

FIG. 24 is a diagram illustrating an example of a hardware configuration of a terminal station device according to each embodiment.

FIG. 25 is a diagram illustrating an example of a communication link of a radio communication system using beamforming in a millimeter wave band.

FIG. 26 is a diagram illustrating an example of a redundant communication link.

FIG. 27 is a diagram illustrating an example of a communication link of a radio communication system when a terminal station device is located near a base station device.

FIG. 28 is a sequence diagram illustrating an operation example of handover control.

### DESCRIPTION OF EMBODIMENTS

Embodiments of the present invention will be described in detail with reference to the drawings.

### First Embodiment

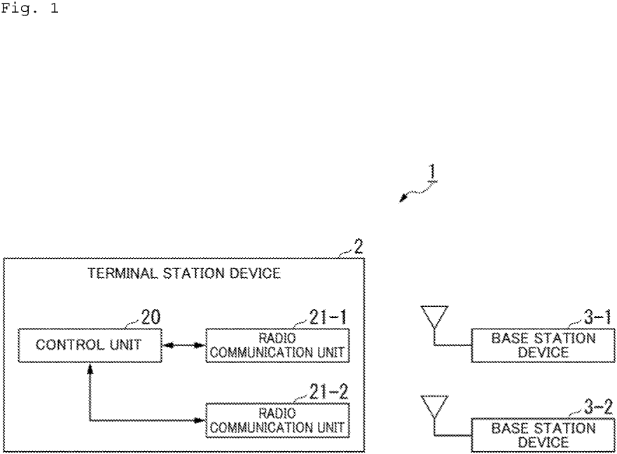

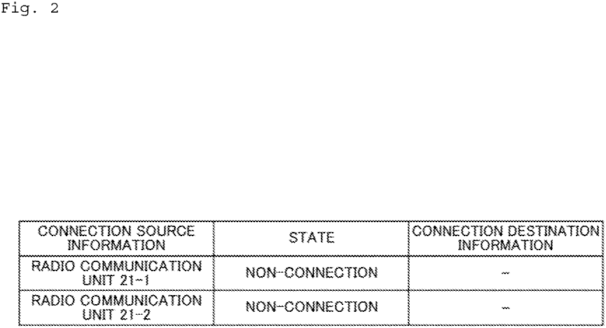

FIG. 1 is a diagram illustrating an example of a configuration of a radio communication system 1 according to a first embodiment. The radio communication system 1 is a system that performs radio communication. The radio communication system 1 includes a terminal station device 2 and a plurality of base station devices 3.

The terminal station device 2 includes the control unit 20 and a plurality of radio communication units 21. In FIG. 1, the plurality of radio communication units 21 are, for example, radio communication units 21-1 and 21-2. Hereinafter, parts of reference numerals are omitted for factors common to each radio communication unit 21, and the radio communication unit is referred to as “radio communication unit 21.” The terminal station device 2 is, for example, an information processing terminal such as a smartphone or a tablet terminal. The terminal station device 2 performs radio communication with the base station device 3.

In FIG. 1, the plurality of base station devices 3 are, for example, base station devices 3-1 and 3-2. Hereinafter, parts of reference numerals are omitted for factors common to each base station device 3, and the base station device is referred to as “base station device 3.” The base station device 3 includes an antenna. The base station device 3 uses the antenna to perform radio communication with the terminal station device 2. The base station device 3 communicates with a high-order network device (not illustrated).

Next, the control unit 20 will be described. The control unit 20 is a functional unit that controls operations of the plurality of radio communication units 21. The control unit 20 stores a state management table. The state management table is a data table for managing each communication state of the plurality of radio communication units 21. The control unit 20 selects the base station device 3 which is a connection destination of each radio communication unit 21 in accordance with each communication state of the plurality of radio communication units 21.

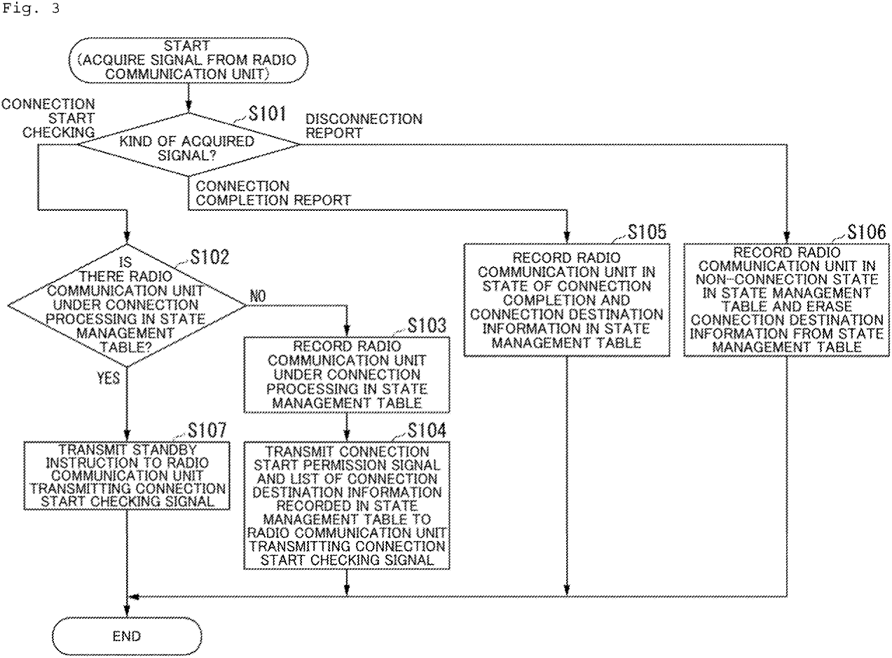

FIG. 2 is a diagram illustrating a first example of a state management table according to the first embodiment. In FIG. 2, connection source information, a state, and connection destination information are associated with each other in the state management table. The connection source information indicates a radio communication unit 21-1 or 21-2. The state indicates a communication state of the radio communication unit 21 and a communication state of the base station device 3. The communication state indicates non-connection, that connection is in progress, or that connection is complete. The connection destination information is information regarding the base station device 3 which is a connection destination and indicates, for example, an identifier of the base station device 3-1 or an identifier of the base station device 3-2.

As information regarding the base station device 3, any information (identifier) with which the base station device 3 can be identified in any communication standard that the base station device 3 supports can be used. For example, the information regarding the base station device 3 may be an identifier with which a logical cell in the upper layer is identified. For example, when the communication standard is “IEEE 802.11ad,” the information regarding the base station device 3 may be expressed using a basic service set identifier (BSSID). For example, when the communication standard is 5G standardized by 3GPP, the information regarding the base station device 3 may be expressed using a physical cell ID (PCI).

In the initial state, the radio communication units 21-1 and 21-2 are not connected to any base station device 3. In the state management table illustrated in FIG. 2, the radio communication unit 21-1 of which a state is non-connection and the radio communication unit 21-2 of which a state is non-connection are recorded to match the communication state in the initial state

For example, each radio communication unit 21 corresponds to the same communication standard. Here, the radio communication unit 21-1 and the radio communication unit 21-2 transmit signals for checking start of connection to the base station device (hereinafter referred to as “connection start checking signals”) to the control unit 20 almost simultaneously. Here, since there is actually a difference in component performance for each radio communication unit 21 and a condition of processing timing of a processor included in the terminal station device 2, the connection start checking signals do not arrive at the control unit 20 simultaneously. Accordingly, for example, the connection start checking signal from the radio communication unit 21-1 arrives at the control unit 20 earlier than the connection start checking signal from the radio communication unit 21-2.

To prepare for a case in which the signal transmitted from the radio communication unit 21-1 and the signal transmitted from the radio communication unit 21 2 arrive at the control unit 20 simultaneously, the control unit 20 may include a functional unit causing the control unit 20 to process a plurality of arriving signals sequentially. The control unit 20 may give an instruction for connection start to the radio communication unit 21-1 and the radio communication unit 21-2 sequentially.

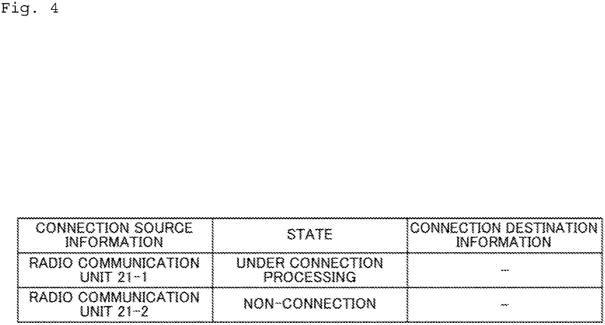

FIG. 3 is a flowchart illustrating an example of an operation of the control unit at the time of acquisition of a signal in the first embodiment. When the control unit 20 acquires a signal from the radio communication unit 21-1, the operation illustrated in FIG. 3 is started. The control unit 20 acquires a signal from a radio communication unit 21-1. The control unit 20 determines the kind of acquired signal (S101).

When it is determined that the acquired signal is the connection start checking signal (step S101: connection start checking), the control unit 20 determines whether the radio communication unit 21 under the connection processing is recorded in the state management table (step S102).

In the initial state, the states of all the radio communication units recorded in the state management table indicate non-connection. In this way, when the radio communication unit 21 under connection processing is not recorded in the state management table (NO in step S102), the control unit 20 records the state of the radio communication unit 21-1 under the connection processing in the state management table (step S103).

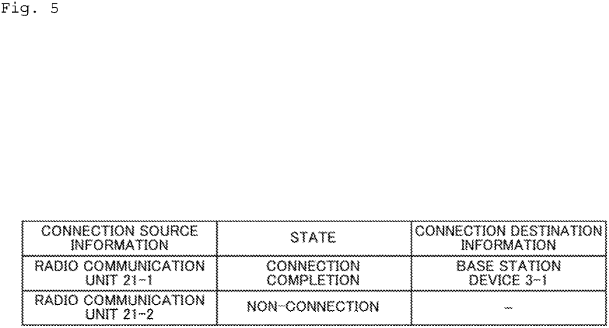

FIG. 4 is a diagram illustrating a second example of the state management table according to the first embodiment. In the state management table illustrated in FIG. 4, the state of the radio communication unit 21-1 under the connection processing and the radio communication unit 21-2 of which a state is notconnection are recorded.

The control unit 20 transmits a connection start permission signal and a list of connection destination information recorded in the state management table to the radio communication unit 21-1. When the radio communication unit 21 in the state of the connection completion is not recorded in the state management table, the control unit 20 transmits a list in which the connection destination information is empty to the radio communication unit 21-1 (S104). The control unit 20 ends the processing illustrated in FIG. 3.

When it is determined that the acquired signal is a signal for reporting the completion of connection to the base station device 3-1 (step S101: a connection completion report), the control unit 20 records the state of the radio communication unit 21-1 which is the state of the connection completion and the connection destination information (information indicating that a connection destination is the base station device 3-1) in the state management table (step S105). The control unit 20 ends the processing illustrated in FIG. 3.

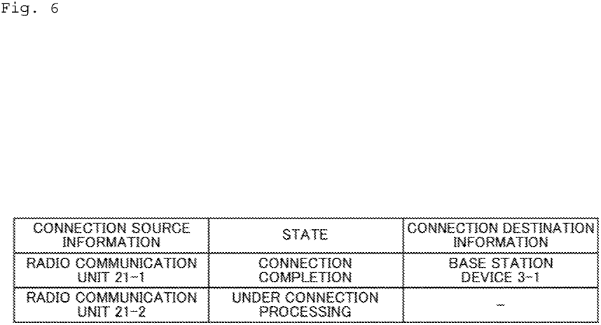

FIG. 5 is a diagram illustrating a third example of the state management table according to the first embodiment. In the state management table illustrated in FIG. 5, the radio communication unit 21-1 of which a connection destination is the base station device 3-1 and the radio communication unit 21-2 of which a state is non-connection are recorded.

When it is determined that the acquired signal is a signal for reporting disconnection of connection to the base station device 3-1 (step S101: a disconnection report), the control unit 20 records state of the radio communication unit 21-1 which is non-connection in the state management table. When the connection destination of the radio communication unit 21-1 is recorded in the state management table, the control unit 20 erases the connection destination information of the radio communication unit 21-1 from the state management table (step S106). The control unit 20 ends the processing illustrated in FIG. 3.

For example, in a time from the operation of step S103 performed for the radio communication unit 21-1 to the operation of step S105 performed for the radio communication unit 21-1, the state of the radio communication unit 21-1 under the connection processing is recorded in the state management table. In this way, when the radio communication unit 21 under connection processing is recorded in the state management table (YES in step S102), the control unit 20 transmits a standby instruction to the radio communication unit 21-2 (step S107). The control unit 20 ends the processing illustrated in FIG. 3.

After the operation of step S105 is performed for the radio communication unit 21-1, the state of the radio communication unit 21-1 under connection processing is not recorded in the state management table (NO in step S102). Therefore, the control unit 20 can perform the operation of step S103 for the radio communication unit 21-2.

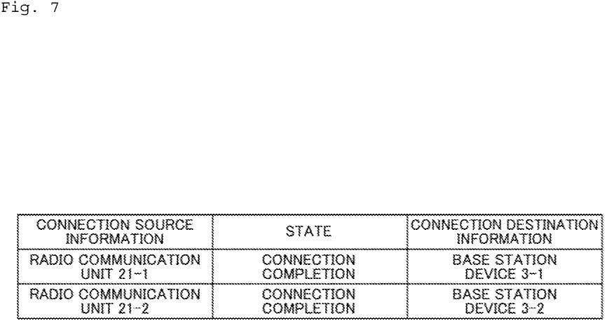

FIG. 6 is a diagram illustrating a fourth example of the state management table according to the first embodiment. In the state management table illustrated in FIG. 6, the radio communication unit 21-1 of which a connection destination is the base station device 3-1 and the state of the radio communication unit 21-2 under connection processing are recorded.

The control unit 20 transmits the connection start permission signal and a list of connection destination information in the state management table (information regarding the base station device 3-1 which is a connection destination of the radio communication unit 21-1) to the radio communication unit 21-2 (S104). The control unit 20 ends the processing illustrated in FIG. 3.

When the acquired signal is a signal for reporting the completion of the connection to the base station device 3-2 (step S102: a connection completion report), the control unit 20 records the state of the radio communication unit 21-2 which is a state of connection completion and connection destination information (information indicating that the connection destination is the base station device 3-2) in the state management table (step S105). The control unit 20 ends the processing illustrated in FIG. 3.

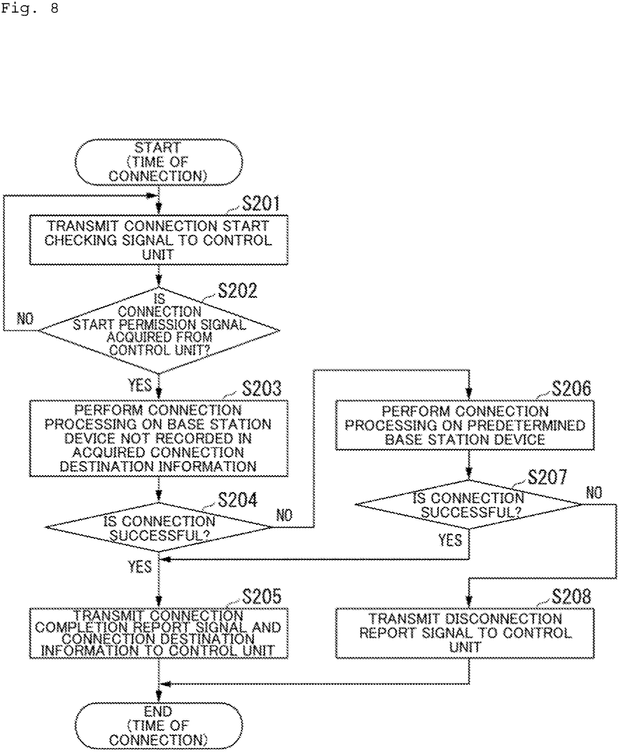

FIG. 7 is a diagram illustrating a fifth example of the state management table according to the first embodiment. In the state management table illustrated in FIG. 7, the radio communication unit 21-1 of which a connection destination is the base station device 3-1 and the radio communication unit 21-2 of which the connection destination is the base station device 3-2 are recorded.

When the acquired signal is a signal for reporting disconnection of connection to the base station device 3-2 (step S102: a disconnection report), the control unit 20 records the radio communication unit 21-2 of which a state is non-connection in the state management table. When the connection destination of the radio communication unit 21-2 is recorded in the state management table, the control unit 20 erases the connection destination information of the radio communication unit 21-2 from the state management table (step S106). The control unit 20 ends the processing illustrated in FIG. 3.

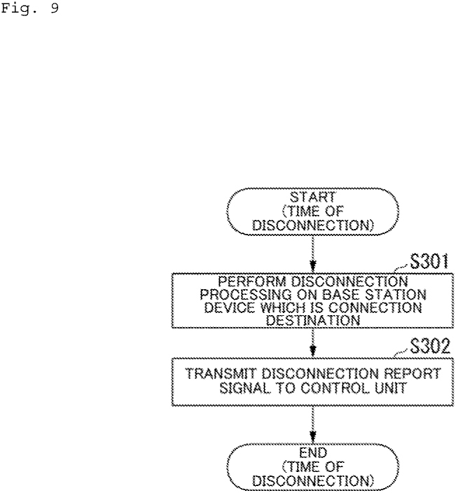

Next, the radio communication unit 21 will be described. FIG. 8 is a flowchart illustrating an example of an operation of the radio communication unit 21 at the time of communication connection according to the first embodiment. When the terminal station device 2 is powered on or a signal corresponding to a user manipulation is input to the terminal station device 2, the operation illustrated in FIG. 8 is started. The radio communication units 21-1 and 21-2 acquire a signal for giving an instruction to start connection processing (hereinafter referred to as a “connection start instruction signal”) based on the same communication standard from the control unit 20.

The radio communication unit 21-1 transmits a connection start checking signal to the control unit 20. Similarly, the radio communication unit 21-2 transmits a connection start checking signal to the control unit 20 (S201).

The radio communication unit 21 determines whether signal for permitting connection start (hereinafter referred to as “connection start permission signal”) and a list of connection destination information are acquired from the control unit 20 (step S202). When it is determined that the connection start permission signal is not acquired (NO in step S202), the radio communication unit 21 returns the processing to step S201.

When the radio communication unit 21-1 acquires the connection start permission signal (YES in step S202), the radio communication unit 21-1 performs connection processing on the base station device 3 not recorded in the list of acquired connection destination information (S203).

The radio communication unit 21-1 determines whether the connection is successful (step S205). For example, when the radio communication unit 21-1 acquires a list of empty connection destination information, the base station device 3 excluded as the connection destination is not in the list of connection destination information. Accordingly, the radio communication unit 21-1 is connected to the base station device 3 without any particular restriction based on a connection procedure determined in the communication standard. For example, when a communication quality index (for example, an RSSI) of the base station device 3-1 located near the terminal station device 2 is first best, the radio communication unit 21-1 is connected to the base station device 3-1.

When the connection is successful (YES in step S205), the radio communication unit 21-1 transmits a connection completion report signal and information regarding the base station device 3-1 which is a connection destination to the control unit 20 (step S205). The radio communication unit 21 ends the processing illustrated in FIG. 8.

When the connection fails because of non-presence of the base station device 3 near the radio communication unit 21 (NO in step S205), the connection processing is performed on the predetermined base station device 3 recorded in the acquired list of the connection processing (step S206).

The radio communication unit 21-1 determines whether the connection is successful (step S207). When the connection is successful (YES in step S207), the radio communication unit 21-1 returns the processing to step S205.

When the connection fails (NO in step S207), the radio communication unit 21-1 transmits a signal for reporting disconnection of the connection to the base station device 3-1 (a disconnection report signal) to the control unit 20 (step S208). The radio communication unit 21 ends the processing illustrated in FIG. 8.

The radio communication unit 21-2 receiving the standby instruction retransmits the connection start checking signal to the control unit 20 (step S201).

When it is determined that the radio communication unit 21-2 acquires the connection start permission signal (YES in step S202), the radio communication unit 21-2 performs the connection processing on the base station devices 3 not recorded in the list of the connection destination information (the base station devices 3 other than the base station devices recorded in the list of the connection destination information) based on the acquired list of the connection destination information (step S203).

The radio communication unit 21-2 determines whether the connection is successful (step S205). For example, when the radio communication unit 21-2 acquires the list of connection destination information in which information regarding the base station device 3-1 is recorded, the radio communication unit 21-2 is connected to the base station device 3 other than the base station device 3-1 based on the connection procedure determined in the communication standard. For example, when the communication quality index (for example, the RSSI) of the base station device 3-2 located near the terminal station device 2 next to the base station device 3-1 is second best, the radio communication unit 21-2 is connected to the base station device 3-2.

When the connection is successful (YES in step S205), the radio communication unit 21-2 transmits the connection completion report signal and information regarding the base station device 3-2 which is a connection destination to the control unit 20 (step S205). The radio communication unit 21 ends the processing illustrated in FIG. 8.

When the connection fails because of non-presence of the base station device 3-2 near the radio communication unit 21 and presence of the base station 3-1 near the radio communication unit 21 (NO in step S205), the radio communication unit 21-2 performs the connection processing on predetermined base station devices 3 including the base station device 3 recorded in the acquired list of the connection destination information (step S206).

The radio communication unit 21-2 determines whether the connection is successful (step S207). When the connection is successful because of the presence of the base station device 3-1 near the radio communication unit 21-2 (YES in step S207), the radio communication unit 21-1 returns the processing to step S205.

When the connection fails because of non-presence of the base station device 3-1 near the radio communication unit 21-2 (NO in step S207), the radio communication unit 21-2 transmits a disconnection report signal to the control unit 20 (step S208). The radio communication unit 21 ends the processing illustrated in FIG. 8.

In this way, both the radio communication units 21-1 and 21-2 are not connected to the base station device 3-1 close to both the radio communication units 21-1 and 21-2. Instead, the radio communication unit 21-2 can be connected to the base station device 3-2 which is the base station device other than the base station device 3-1. Since a communication link formed by the radio communication unit 21-1 and a communication link formed by the radio communication unit 21-2 are separated from each other, resistance to blocking or the like is improved.

Further, it is necessary to prevent the information regarding the unnecessary base station device 3 from being continuously recorded in the state management table stored in the control unit 20. Therefore, when the communication link is disconnected due to reception of a user manipulation or blocking of a propagation path of a radio signal, the radio communication unit 21 reports the disconnection of the communication link to the control unit 20.

FIG. 9 is a flowchart illustrating an example of an operation of the radio communication unit at the time of communication disconnection according to the first embodiment. In FIG. 9, as an example, the radio communication unit 21-1 starts processing for disconnecting a communication link between the radio communication unit 21-1 and the base station device 3-1. The radio communication unit 21-1 performs disconnection processing on the base station device 3-1 which is a connection destination based on the connection procedure determined in the communication standard (S301). After the disconnection processing is completed, the radio communication unit 21-1 transmits a disconnection report signal to the control unit 20 (step S302). The radio communication unit 21-1 ends the processing illustrated in FIG. 9.

In the flowchart illustrated in FIG. 3, when the acquired signal is a signal for reporting disconnection of the connection to the base station device 3-1 (step S102: a disconnection report), the control unit 20 records the non-connection state of the radio communication unit 21-1 in the state management table. When a connection destination of the radio communication unit 21-1 is recorded in the state management table, the control unit 20 erases the connection destination information of the radio communication unit 21-1 from the state management table (step S106). The control unit 20 ends the processing illustrated in FIG. 3.

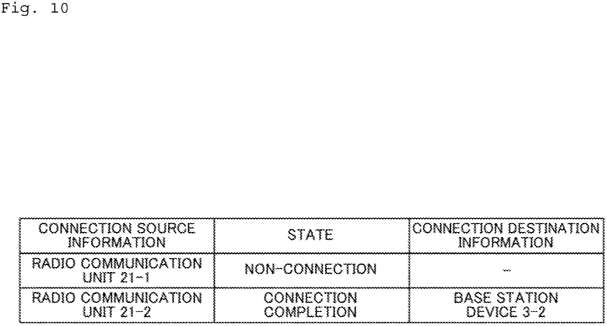

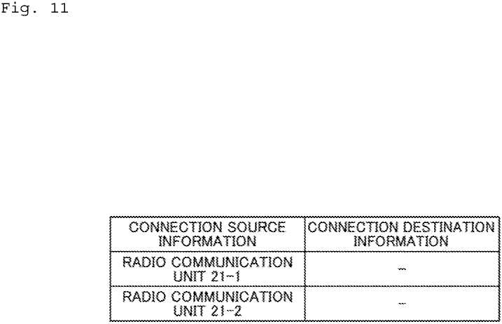

FIG. 10 is a diagram illustrating a sixth example of the state management table according to the first embodiment. In the state management table illustrated in FIG. 10, the radio communication unit 21-1 of which a state is non-connection and the radio communication unit 21-2 of which a connection destination is the base station device 3-2 are recorded.

As described above, the radio communication unit 21-1 is connected to the base station device 3-1 among the plurality of surrounding base station devices 3. The control unit 20 records information regarding the base station device 3-1 as connection destination information (first connection destination information) of the radio communication unit 21-1 in a storage unit. The radio communication unit 21-2 is connected to the base station device 3-2 different from the base station device 3-1 with regard to the connection destination information of the radio communication unit 21-1 (first connection destination information) among the plurality of base station devices 3-1.

In this way, the radio communication unit 21-2 is connected to the base station device 3-2 different from the base station device 3-1 based on the connection destination information of the radio communication unit 21-1 in the state management table. Thus, since the radio communication unit 21-2 is not connected to the base station device 3-1 to which the radio communication unit 21-1 is connected, the communication link becomes redundant and the stability of communication can be improved.

Since connection of the plurality of radio communication units 21 to the same base station device 3 is avoided, the stability of communication can be improved as a redundancy effect of the communication link. Since the communication links become redundant by preventing the communication links from being close to each other and achieving of distribution of the propagation paths, the stability of communication between the high-order network device (not illustrated) of the base station device 3 and the terminal station device 2 can be improved. Further, since the terminal station device 2 includes the plurality of radio communication units 21 in conformity to the same communication standard, the communication link of the terminal station device 2 becomes redundant. Therefore, it is possible to inhibit a possibility of the plurality of communication links being simultaneously disconnected.

### Second Embodiment

A second embodiment differs from the first embodiment in that the control unit 20 changes the selection of the base station device 3 which is a connection destination of the radio communication unit 21 after the connection of each radio communication unit 21 to the base station device 3 is completed. In the second embodiment, differences from the first embodiment will be mainly described.

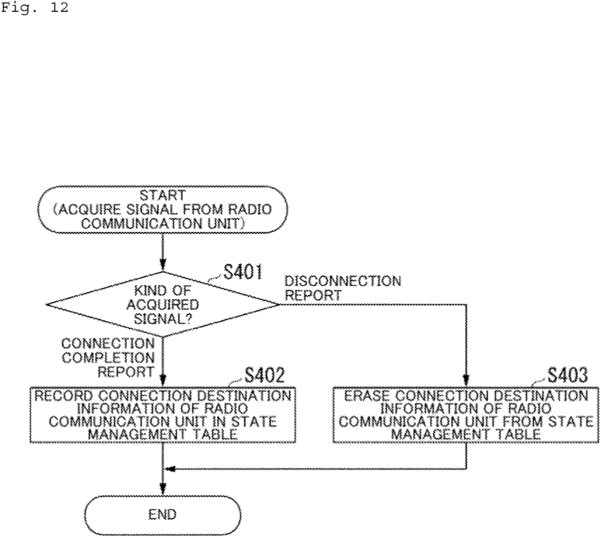

FIG. 11 is a diagram illustrating a first example of a state management table according to a second embodiment. In the state management table according to the second embodiment, connection source information and connection destination information are associated with each other. In the initial state, the radio communication units 21-1 and 21-2 are not connected to any base station device 3. In the state management table illustrated in FIG. 11, the radio communication unit 21-1 of which a state is non-connection and the radio communication unit 21-2 of which a state is non-connection are recorded to match the communication state in the initial state.

After each radio communication unit 21 is connected to the base station device 3, the control unit 20 changes selection of the base station device 3 which is a connection destination of the radio communication unit 21. With this change, for example, two radio communication units 21-1 are connected to the base station device 3-1 located at a position close to the terminal station device 2-1. The radio communication unit 21-2 is connected to the base station device 3-2 located at a position away from the terminal station device 2-2.

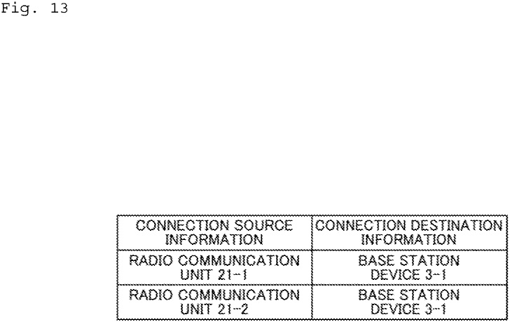

FIG. 12 is a flowchart illustrating an example of an operation of the control unit 20 at the time of acquisition of a signal according to the second embodiment. The control unit 20 acquires a connection completion report signal or a disconnection report signal from the radio communication unit 21. The control unit 20 determines a kind of the acquired signal (S401).

When it is determined that the acquired signal is the connection completion report signal (step S401: a connection completion report), the control unit 20 records information regarding the base station device 3 which is a connection destination of the radio communication unit 21 transmitting the connection completion report signal in the state management table as connection destination information of the radio communication unit 21 transmitting the connection completion report signal (step S402). The control unit 20 ends the processing illustrated in FIG. 12.

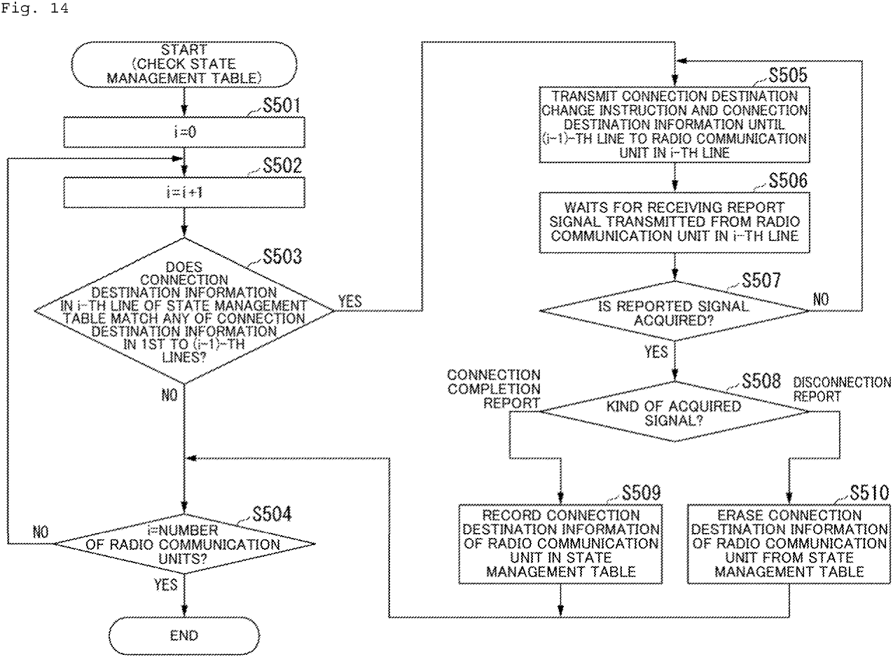

FIG. 13 is a diagram illustrating a second example of the state management table according to the second embodiment. As an example, the radio communication units 21-1 and 21-2 are simultaneously connected to the base station device 3-1 at a position closest to the terminal station device 2. Therefore, in the state management table illustrated in FIG. 13, the radio communication unit 21-1 of which a connection destination is the base station device 3-1 and the radio communication unit 21-2 of which a connection destination is the base station device 3-1 are recorded.

When it is determined that the acquired signal is a signal for reporting disconnection of the connection to the base station device 3 (step S401: a disconnection report), the control unit 20 records a non-connection state of the radio communication unit 21 transmitting the disconnection report signal in the state management table. When the connection destination of the radio communication unit 21 transmitting the disconnection report signal is recorded in the state management table, the control unit 20 erases the connection destination information of the radio communication unit 21 transmitting the disconnection report signal from the state management table (step S403). The control unit 20 ends the processing illustrated in FIG. 3.

In a situation where the radio communication unit 21 1 and the radio communication unit 21 2 at a position close to the terminal station device 2 are simultaneously connected to the base station device 3-1, a plurality of communication links between the two radio communication units 21 and the base station device 3-1 are highly likely to be simultaneously disconnected when an obstruction is entered between the terminal station device 2 and the base station device 3-1.

To inhibit a possibility of a plurality of communication links being simultaneously disconnected, in the second embodiment, the control unit 20 transmits an instruction to change the selection of the connection destination to one or more radio communication units 21 as necessary. That is, the control unit 20 transmits an instruction to change the selection of the connection destination to one or more radio communication units 21 in accordance with a checking result of recording of the state management table.

For example, the control unit 20 checks content of the state management table at a predetermined cycle and transmits an instruction to change the selection of the connection destination at the predetermined cycle. For example, the control unit 20 may transmit an instruction to change the selection of the connection destination at the predetermined cycle at any timing (for example, at a timing at which step S402 or step S403 is performed).

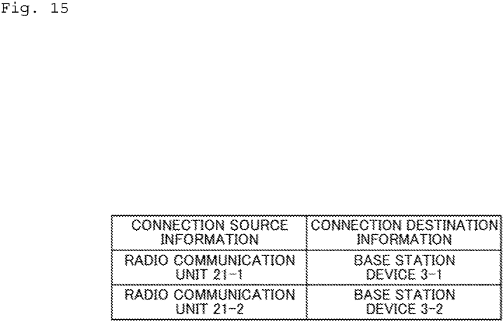

FIG. 14 is a flowchart illustrating an example of an operation of the control unit 20 at the time of checking of the state management table according to the second embodiment. The control unit 20 checks content of the state management table at a predetermined timing. Here, the control unit 20 resets a counter “i” to 0 (step S501). The control unit 20 counts up the counter “i” (step S502).

The control unit 20 determines whether the connection destination information of the radio communication unit 21-1 associated with the counter “i” which has been counted up matches any of the connection destination information of the radio communication unit 21 associated with each counter “1 to (i-1)” before the counting-up in the state management table. That is, the control unit 20 determines whether the connection destination information in an i-th line of the state management table matches any of the connection destination information from the 1st to (i-1)-th lines of the state management table in the state management table (step S503).

When step S503 is performed for the first time, it is determined that the connection destination information does not match each other. In this way, when it is determined that the connection destination information does not match each other (NO in step S503), the control unit 20 determines whether a value of the counter “i” matches the number of radio communication units 21 (step S504).

When step S504 is performed for the first time, the value “1” of the counter “i” does not match the number “2” of radio communication units 21. In this case, it is determined that the value of the counter “i” does not match the number of radio communication units 21.

When it is determined that the value of the counter “i” does not match the number of radio communication units 21 (NO in step S504), the control unit 20 returns the processing to step 503.

When the number of times step S503 is performed is 2 or more, the connection destination of the radio communication unit 21-2 matches the connection destination of the radio communication unit 21-1 in the state management table illustrated in FIG. 13.

When it is determined that the connection destination information matches each other (YES in step S503), the control unit 20 transmits information regarding the base station devices 3 (for example, identifiers of the base station devices 3-1) from the 1st to (i-1)-th lines to which the radio communication unit 21-1 is connected and an instruction to change the selection of the connection destination (hereinafter referred to as a “connection destination change instruction”) to the radio communication unit 21 in the i-th line of the state management table (the radio communication unit 21-2) (step S505). The control unit 20 waits for receiving a report signal (a connection completion report signal or a disconnection report signal) transmitted from the radio communication unit 21 in the i-th line of the state management table (step S506).

The control unit 20 determines whether the report signal has been acquired from the radio communication unit 21 in the i-th line of the state management table (the radio communication unit 21-2) (step S507). When it is determined that report signal has not been acquired (NO in step S507), the control unit 20 returns the processing to step S505. When it is determined that the report signal has been acquired (YES in step S507), the control unit 20 determines whether the acquired signal is the connection completion report signal or the disconnection report signal (step S508).

When it is determined that the signal acquired from the radio communication unit 21 in the i-th line (the radio communication unit 21-2) is the connection completion report signal to the base station device 3-2 (step S508 : a connection completion report), the control unit 20 records information regarding the base station device 3-2 (an identifier of the base station device 3-2) which is a connection destination of the radio communication unit 21-2 transmitting the connection completion report signal as connection destination information in the state management table (step S509). The control unit 20 returns the processing to step S504.

In step S504, it is redetermined whether the value of the counter “i” matches the number “2” of the radio communication units 21. When it is determined that the value of the counter “i” matches the number of radio communication units 21 (YES in step S504), the control unit 20 ends the processing illustrated in FIG. 14.

FIG. 15 is a diagram illustrating a third example of the state management table according to the second embodiment. In the state management table illustrated in FIG. 15, the radio communication unit 21-1 of which a connection destination is the base station device 3-1 and the radio communication unit 21-2 of which a connection destination is the base station device 3-2 are recorded.

In this way, it is possible to achieve distribution of connection destinations in that one of the radio communication units 21-1 and 21-2 is connected to the base station device 3-2 without connecting both the radio communication units 21-1 and 21-2 to the base station device 3-1 closest to the terminal station device 2. Accordingly, since the communication link formed by the radio communication unit 21-1 and the communication link formed by the radio communication unit 21-2 are separated from each other, resistance to blocking or the like is improved.

When a signal acquired from the radio communication unit 21 is a signal for reporting disconnection of the connection to the base station device 3 (step S508: a disconnection report), the control unit 20 records the non-connection state of the radio communication unit 21 transmitting the disconnection report signal in the state management table. When the connection destination of the radio communication unit 21 transmitting the disconnection report signal is recorded in the state management table, the control unit 20 erases the connection destination information of the radio communication unit 21 transmitting the disconnection report signal from the state management table (S510). The control unit 20 returns the processing to step S504.

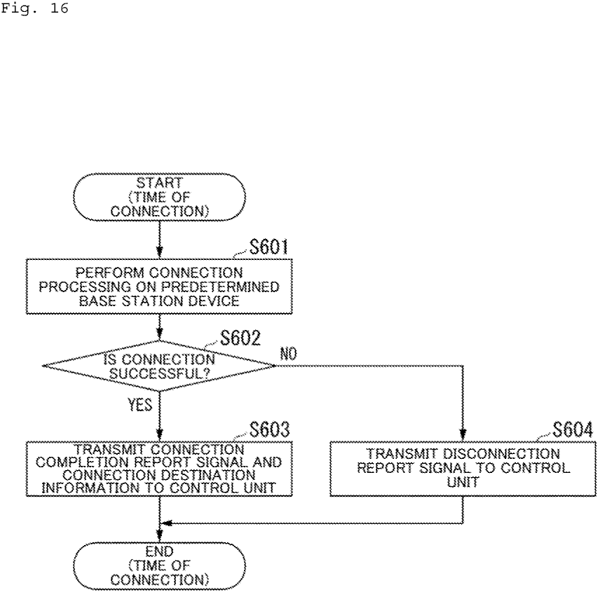

FIG. 16 is a flowchart illustrating an example of an operation of the radio communication unit 21 at the time of communication connection according to the second embodiment. When the terminal station device 2 is powered on or a signal corresponding to a user manipulation is input to the terminal station device 2, the operation illustrated in FIG. 16 is started. The radio communication units 21-1 and 21-2 acquire the connection start instruction signal from the control unit 20.

The radio communication unit 21-1 performs the connection processing to a predetermined base station device 3 based on a connection procedure determined in a communication standard. Similarly, the radio communication unit 21-2 performs the connection processing to the predetermined base station device 3 based on a connection procedure defined in the communication standard (step S601).

The radio communication unit 21 determines whether the connection is successful (S602). When it is determined that the connection is successful (YES in step S602), the radio communication unit 21 transmits the connection completion report signal to the control unit 20. The radio communication unit 21 transmits information regarding the base station device 3 which is a connection destination of the own radio communication unit to the control unit 20 as connection destination information (step S603). The radio communication unit 21 ends the processing illustrated in FIG. 16.

When it is determined that the connection fails (NO in step S602), the radio communication unit 21 transmits the disconnection report signal to the control unit 20 (step S604). The radio communication unit 21 ends the processing illustrated in FIG. 16.

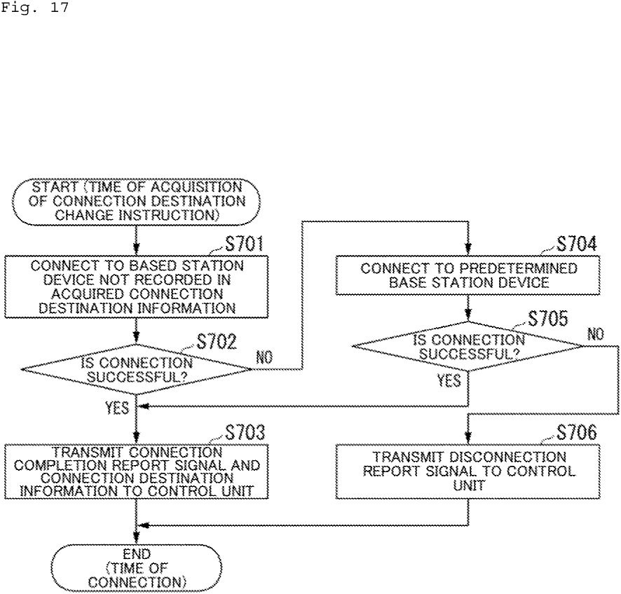

FIG. 17 is a flowchart illustrating an example of an operation of the radio communication unit 21 at the time of changing of a connection destination according to the second embodiment. The radio communication unit 21-2 acquires the connection destination change instruction from the control unit 20. The radio communication unit 21-2 performs the connection processing to the base station device 3 other than the base station device of the connection destination information (for example, an identifier of the base station device 3-1) acquired from the control unit 20 based on a connection procedure determined in the communication standard (step S701).

The radio communication unit 21-2 determines whether the connection is successful (step S702). When the connection is successful (YES in step S702), the radio communication unit 21-2 transmits the connection completion report signal and information regarding the base station device 3 which is a connection destination to the control unit 20. For example, when the communication quality index of the base station device 3-2 located at a position close to the terminal station device 2 next to the base station device 3-1 is the best, the radio communication unit 21-2 transmits the connection completion report signal and information (connection destination information) regarding the base station device 3-2 which is a connection destination to the control unit 20 (step S703). The radio communication unit 21 ends the processing illustrated in FIG. 17.

When it is determined that the connection fails because of non-presence of the base station device 3-2 near the radio communication unit 21 and presence of the base station device 3-1 near the radio communication unit 21 (NO in step S702), the radio communication unit 21-2 performs the connection processing on a predetermined base station devices 3 including the base station device (the base station device 3-1) recorded in the acquired list of the connection destination information (step S704).

The radio communication unit 21-2 determines whether the connection is successful (step S705). When it is determined that the connection to the base station device 3 1 is successful (YES in step S705), the radio communication unit 21-2 returns the processing to step S703. When it is determined that the connection fails (NO in step S705), the radio communication unit 21-2 transmits the disconnection report signal to the control unit 20 (step S706). The radio communication unit 21 ends the processing illustrated in FIG. 17.

It is necessary to prevent the information regarding the unnecessary base station device 3 from being continuously recorded in the state management table stored in the control unit 20. Therefore, when the communication link is disconnected due to reception of a user manipulation or blocking of a propagation path of a radio signal, the radio communication unit 21 reports the disconnection of the communication link to the control unit 20. Here, the radio communication unit 21 performs the operation of the flowchart illustrated in FIG. 9. The control unit 20 performs the operation of the flowchart illustrated in FIG. 12.

As described above, the radio communication unit 21-1 is connected to a first connection destination which is the base station device 3-1 among the plurality of surrounding base station devices 3. The radio communication unit 21-2 is connected to a second connection destination which is the base station device 3-1 or the base station device 3-2 among the plurality of base station devices 3. The control unit 20 determines whether the connection destination (the first connection destination) of the radio communication unit 21-1 is the same as the connection destination (the second connection destination) of the radio communication unit 21-2. When it is determined that the connection destination of the radio communication unit 21-1 is the same as the connection destination of the radio communication unit 21-2, the control unit 20 changes the connection destination (the second connection destination) of the radio communication unit 21-2 to the base station device 3-2.

In this way, when it is determined that the connection destination of the radio communication unit 21-1 is the same the connection destination of the radio communication unit 21-2, the control unit 20 changes the connection destination of the radio communication unit 21-2 to the base station device 3-2. That is, when the plurality of radio communication units 21 are connected to the same base station device 3, the control unit 20 detects that the plurality of radio communication units 21 are connected to the same base station device 3 and the control unit 20 changes selection of the connection destination of the radio communication unit 21 so that one or more radio communication unit 21 among the plurality of radio communication units 21 are connected to other base stations device 3. Accordingly, the communication link can be redundant, and the stability of communication can be improved.

### Third Embodiment

In the first and second embodiments, as in “IEEE 802.11ad” or “IEEE 802.11ay,” a radio communication unit independently selects a base station device which is a connection destination. A third embodiment differs from the first and second embodiments in that a radio communication system corresponds to the handover control of a centralized control type communication scheme such as 5G standardized by 3GPP. In the third embodiment, differences from the first embodiment and the second embodiment will be mainly described.

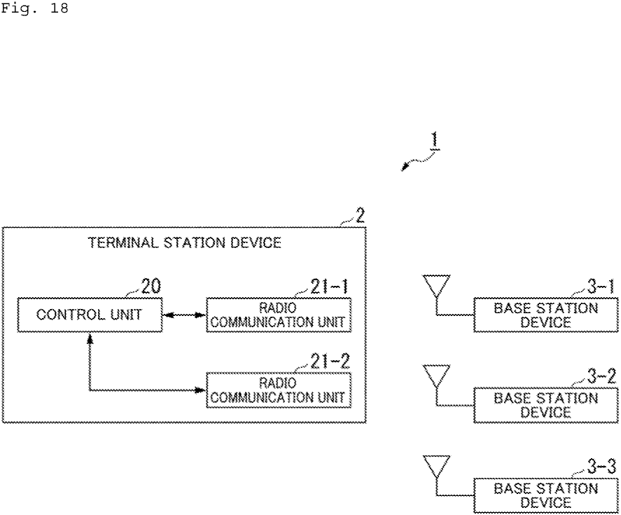

FIG. 18 is a diagram illustrating an example of a configuration of the radio communication system 1 according to the third embodiment. In FIG. 18, a plurality of base station devices 3 are, for example, base station devices 3-1, 3-2, and 3-3. In FIG. 18, the radio communication unit 21-1 is connected to the base station device 3-1. The radio communication unit 21-2 is connected to the base station device 3-2.

The radio communication system 1 performs the handover control based on the centralized control type communication scheme by a high-order network device (not illustrated). In the handover control, the base station device 3 is selected as a connection destination of the terminal station device 2 in accordance with a measurement result of the surrounding environment of the terminal station device 2. The terminal station device 2 acquires an identifier of the base station device 3 selected as the connection destination of the terminal station device 2 as a handover instruction from the high-order network device (not illustrated).

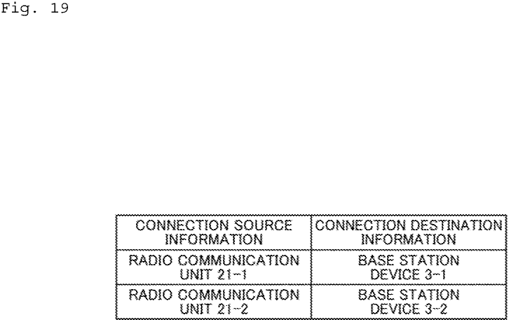

FIG. 19 is a diagram illustrating a first example of a state management table according to the third embodiment. In the state management table illustrated in FIG. 19, the radio communication unit 21-1 of which a connection destination is the base station device 3-1 and the radio communication unit 21-2 of which a connection destination is the base station device 3-2 are recorded.

In FIG. 18, for example, connection of the radio communication unit 21-1 to the base station device 3-1 has been completed. The position of the base station device 3-1 is closer to the position of the terminal station device 2 than the position of the base station device 3-2. Further, the position of the base station device 3-1 is closer to the position of the terminal station device 2 than the position of the base station device 3-3. Accordingly, the control unit 20 controls an operation of the radio communication unit 21-2 so that the radio communication unit 21-2 is connected to the base station device 3-3 located at a position away from the terminal station device 2, instead of connection of the radio communication unit 21-2 to the base station device 3-1.

Subsequently, the radio communication unit 21-2 acquires an instruction to measure an environment around the terminal station device 2 from the high-order network device (not illustrated) connected to the base station device 3-2 which is a connection destination before the handover processing is performed.

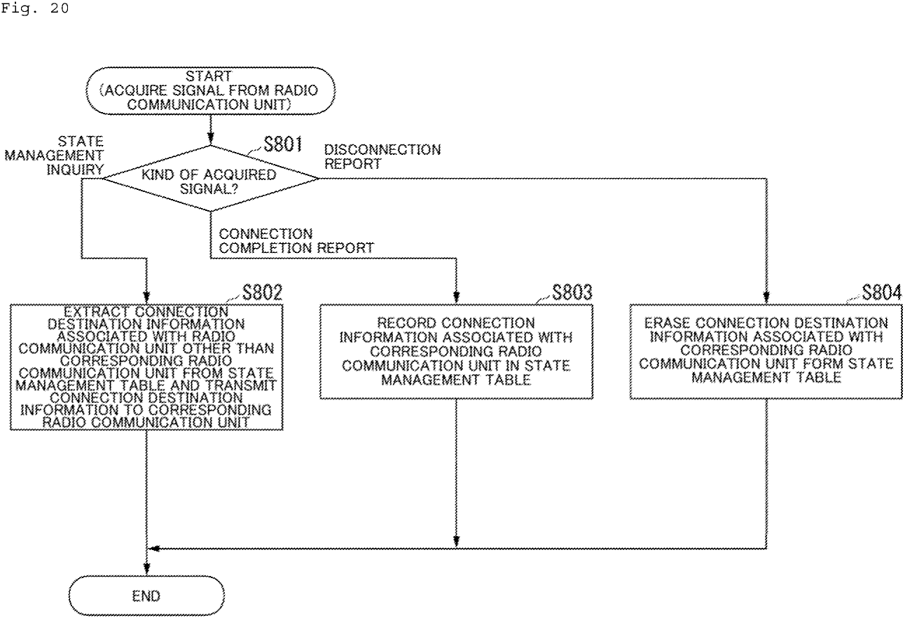

FIG. 20 is a flowchart illustrating an example of an operation of the control unit 20 at the time of acquisition of a signal in the third embodiment. The control unit 20 acquires a signal for inquiring connection destination information in the state management table (hereinafter referred to as a “state management inquiry signal”), a connection completion report signal, or a disconnection report signal from the radio communication unit 21. The control unit 20 determines a kind of the acquired signal (S801).

When it is determined that the signal acquired from the radio communication unit 21-2 is the state management inquiry signal (step S801: a state management inquiry), the control unit 20 extracts connection destination information associated with the radio communication unit 21 other than the radio communication unit 21-2 from the state management table. The control unit 20 transmits the extracted connection destination information to the radio communication unit 21-2 transmitting the state management inquiry signal. That is, the control unit 20 transmits information regarding the base station device 3-1 (for example, an identifier of the base station device 3-1) which is the connection destination of the radio communication unit 21-1 recorded in the state management table to the radio communication unit 21-2 (step S802). The control unit 20 ends the processing illustrated in FIG. 20.

When it is determined that the signal acquired from the radio communication unit 21-2 is a connection completion report signal (step S801: a connection completion report signal), the control unit 20 records connection destination information associated with the radio communication unit 21-2 (information regarding a base station device 3-3 which is a connection destination of the radio communication unit 21-2) in the state management table (step S803). The control unit 20 ends the processing illustrated in FIG. 20.

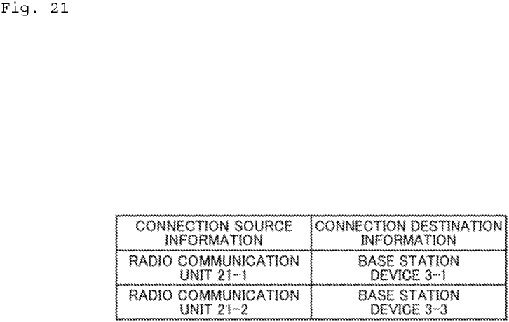

FIG. 21 is a diagram illustrating a first example of the state management table according to the third embodiment. In the state management table illustrated in FIG. 21, the radio communication unit 21-1 of which a connection destination is the base station device 3-1 and the radio communication unit 21-2 of which the connection destination is the base station device 3-3 as a result of the handover control are recorded.

When it is determined that the signal acquired from the radio communication unit 21-1 is a disconnection report signal (step S801: a disconnection report signal), the control unit 20 records the non-connection state of the radio communication unit 21-1 transmitting the disconnection report signal in the state management table. When the connection destination of the radio communication unit 21-1 transmitting the disconnection report signal is recorded in the state management table, the control unit 20 erases the connection destination information of the radio communication unit 21-1 transmitting the disconnection report signal from the state management table (step S804). The control unit 20 ends the processing illustrated in FIG. 20.

Next, an example of an operation of the radio communication unit 21 at the time of acquisition of a measurement instruction will be described.

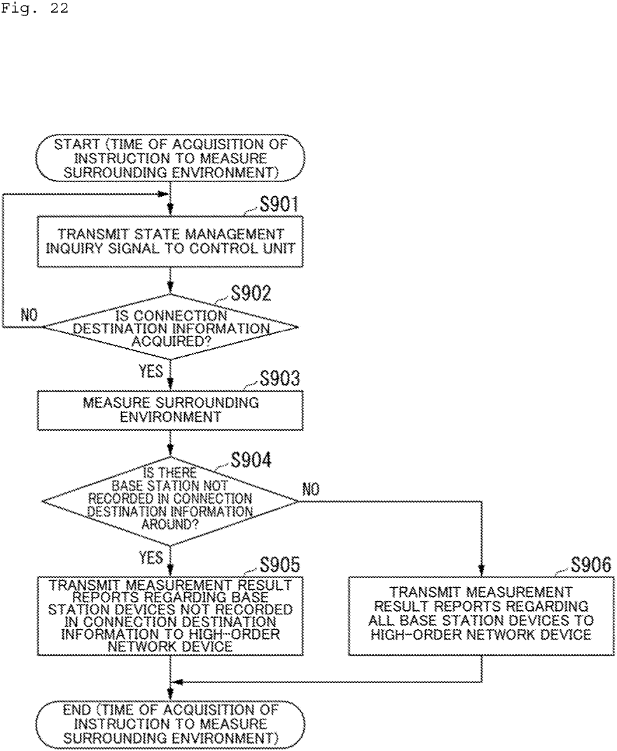

FIG. 22 is a flowchart illustrating an example of an operation of the radio communication unit 21 at the time of acquisition of a measurement instruction according to the third embodiment. The radio communication unit 21-2 acquires an instruction to measure an environment around the terminal station device 2 from the high-order network device (not illustrated) connected to the base station device 3-2.

The radio communication unit 21-2 transmits the state management inquiry signal to the control unit 20 (step S901). The radio communication unit 21-2 determines whether the connection destination information is acquired from the control unit 20 (step S902) . When the connection destination information is not acquired (NO in step S902), the radio communication unit 21-2 returns to the processing to step S901.

When the connection destination information is acquired (YES in step S902), the radio communication unit 21-2 measures a surrounding environment (step S903). The information regarding the surrounding environment is, for example, information regarding the base station device 3-1, information regarding the base station device 3-2, and information regarding the base station device 3-3. The information regarding the base station device 3 is, for example, reference signal received power (RSRP) or reference signal received quality (RSRQ) related to the radio communication unit 21-2 and the base station device 3.

The radio communication unit 21-2 determines whether the base station devices 3 other than the base station device 3-1 are around the terminal station device 2 (step S904). When it is determined that the base station devices 3 other than the base station device 3-1 are around the terminal station device 2 (YES in step S904), the radio communication unit 21-2 transmits measurement result reports regarding the base station devices 3 (in FIG. 18, the base station devices 3-2 and 3-3) not recorded in the connection destination information to the high-order network device (not illustrated) (step S905). The radio communication unit 21-2 ends the processing illustrated in FIG. 22.

When it is determined that the base station device 3 other than the base station device 3-1 are not around the terminal station device 2 (NO in step S904), the radio communication unit 21-2 transmits measurement result reports regarding all the base station devices 3 to the high-order network device (not illustrated). Instead of the transmission of the measurement result reports regarding all the base station devices 3 to the high-order network device (not illustrated) by the radio communication unit 21-2, the control unit 20 may transmit the measurement result reports regarding all the base station devices 3 to the high-order network device (not illustrated) (step S906). The radio communication unit 21-2 ends the processing illustrated in FIG. 22.

It is assumed that each radio communication unit 21 simultaneously receives an instruction to measure a surrounding environment in accordance with a communication scheme. When the base station device 3 which is a connection destination of the plurality of radio communication units 21 overlap, handover processing may be simultaneously performed to the base station device 3 different from the base station device 3 to which the plurality of radio communication units 21 are connected, and thus there is a possibility of the plurality of radio communication units 21 being connected to the same base station device 3 again. Each operation of the control unit 20 and the radio communication unit 21 may be changed so that such handover processing is not performed. For example, the control unit 20 may not respond to other state management inquiry signals until a predetermined time has passed after transmission of the connection destination information to the radio communication unit 21 by the control unit 20 and reception of the state management inquiry signal by the control unit 20.

Next, an example of an operation of the radio communication unit 21 at the time of acquisition of a handover instruction will be described.

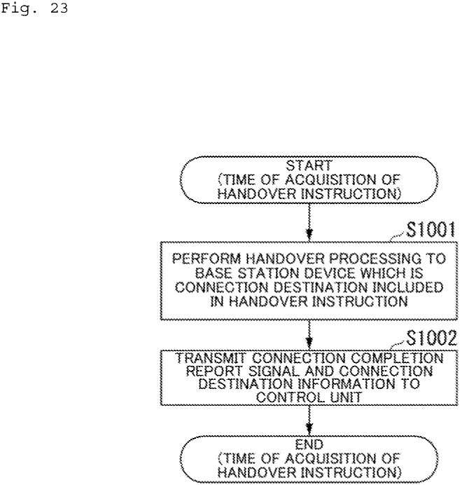

FIG. 23 is a flowchart illustrating an example of an operation of the radio communication unit 21 at the time of acquisition of a handover instruction according to the third embodiment. A high-order network device (not illustrated) acquires information regarding the base station device 3-2 and information regarding the base station device 3-3 from the terminal station device 2. The high-order network device (not illustrated) selects the base station device 3 which becomes a connection destination of the radio communication unit 21-2 between the base station device 3-2 and the base station device 3-3 based on the information regarding the base station device 3-2 and the information regarding the base station device 3-3. The high-order network device (not illustrated) instructs the radio communication unit 21-2 to perform handover to the selected base station device 3.

For example, when communication quality of a communication link between the radio communication unit 21-2 and the base station device 3-2 deteriorates and communication quality between the radio communication unit 21-2 and the base station device 3-3 is better, the high-order network device (not illustrated) instructs the radio communication unit 21-2 to perform handover to the base station device 3-3.

The radio communication unit 21-2 acquires a handover instruction from a high-order network device (not illustrated) connected to the base station device 3-2. The radio communication unit 21-2 performs handover processing to the base station device 3-3 based on a handover instruction and a connection procedure determined in the communication standard (S1001). The radio communication unit 21-2 transmits a connection completion report signal and the connection destination information (information regarding the base station device 3-3) to the control unit 20 (step S1002) . The radio communication unit 21-2 ends the processing illustrated in FIG. 23.

Next, an example of an operation of the radio communication unit 21 at the time of communication disconnection will be described.

It is necessary to prevent information regarding the unnecessary base station device 3 from being continuously recorded in the state management table stored in the control unit 20. Therefore, when the communication link is disconnected due to reception of a user manipulation or blocking of a propagation path of a radio signal, the radio communication unit 21 reports the disconnection of the communication link to the control unit 20. Here, the radio communication unit 21 performs the operation of the flowchart illustrated in FIG. 9. The control unit 20 performs the operation of the flowchart illustrated in FIG. 12.

As described above, the radio communication unit 21-1 is connected to the base station device 3-1 among the plurality of base station devices 3 which are around the terminal station device 2. The control unit 20 records information regarding the base station device 3-1 as connection destination information (the first connection destination information) of the radio communication unit 21-1 in a storage unit. The radio communication unit 21-2 measures communication quality of each base station device 3 with respect to the plurality of base station devices 3 which are around the terminal station device 2. The radio communication unit 21-2 transmits information regarding communication quality of each base station device 3 other than the base station device 3-1 with regard to the connection destination information (the first connection destination information) of the radio communication unit 21-1 to the high-order network device (not illustrated). The high-order network device (not illustrated) performs handover control of the radio communication unit 21 based on information regarding communication quality of each base station device 3 other than the base station device 3-1. The radio communication unit 21-2 is connected to, for example, the base station device 3-3 based on the handover control by the high-order network device (not illustrated).

In this way, the radio communication unit 21-2 transmits information regarding communication quality of each base station device 3 other than the base station device 3-1 to the high-order network device (not illustrated) performing the handover control of the radio communication unit 21. Accordingly, the stability of communication can be improved. Not the high-order network device connected to the base station device 3 but the terminal station device 2 can perform processing for avoiding connection of the plurality of radio communication units 21 conforming to a centralized control type radio communication standard to the same base station device 3.

Next, common factors in each of the first to third embodiments will be described.

The number of radio communication units 21 included in the terminal station device 2 may be three or more. As the number of the radio communication units 21 is larger, simultaneous connection to the plurality of base station devices 3 at different positions is possible. Therefore, stable communication with the high-order network device (not illustrated) due to redundancy can be maintained.

The radio communication unit 21 may be provided inside the casing of the terminal station device 2 or may be provided outside of the casing of the terminal station device 2. Each radio communication unit 21 may perform communication using an antenna common to each radio communication unit 21, may perform communication using each region into which an array antenna is divided, or may perform communication using an antenna of each radio communication unit 21.

The communication standard is not limited to a specific communication standard such as an autonomous distributed type or a centralized control type communication standard A frequency used for communication is not limited to a specific frequency. The terminal station device 2 corresponding to any communication standard may limit a connection destination of the base station device 3 based on the communication standard.

An antenna configuration of the base station device 3 may be a distributed antenna configuration. The distributed antenna configuration is a configuration in which a plurality of antennas provided at positions away from the base station device 3 are accommodated in the base station device 3. In this case, as any information with which the base station device 3 can be identified, the same information is transmitted from a plurality of antennas provided at positions apart from the base station device 3.

Here, the terminal station device 2 may not attempt connection to another base station device 3 different from the connected base station device 3. The terminal station device 2 may attempt connection to another antenna in the distributed antenna configuration. Accordingly, it is possible to obtain the redundancy effects of the communication link. In this case, the base station device 3 may embed information with which the base station device 3 can be identified and information with which the distributed antennas can be identified in a signal to be transmitted to the terminal station device 2. The radio communication unit 21 may use information with which the antennas arranged in a distributed manner can be identified for attempt of connection. The radio communication unit 21 may use a measurement result of a position and a direction of the base station device 3 for attempt of connection. The radio communication unit 21 may use information with which a radio propagation path between the radio communication unit 21 and the base station device 3 can be identified for attempt of connection.

In each embodiment, as a convenient representation in accordance with a positional relationship between the devices, a device of a representation-fixed station is represented as a base station device and a device of a communication station is represented as a terminal station device. A role of the base station device 3 is not limited to each role of a base station (BS), an access point (AP), and an initiator in a predetermined communication standard. A role of the terminal station device 2 is not limited to each role of a user terminal (UE), a station (STA), and a responder in a predetermined communication standard. The terminal station device 2 and the base station device 3 may execute a role (a function) of a communication device defined in a predetermined communication standard. For example, the base station device 3 installed on the ground may execute a function of a station and the mobile terminal station device 2 may execute a function of an access point.

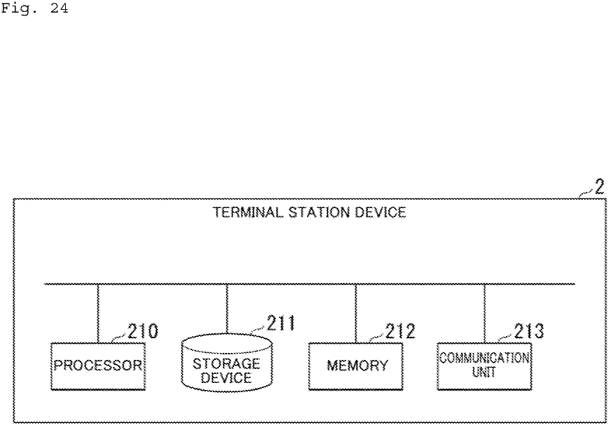

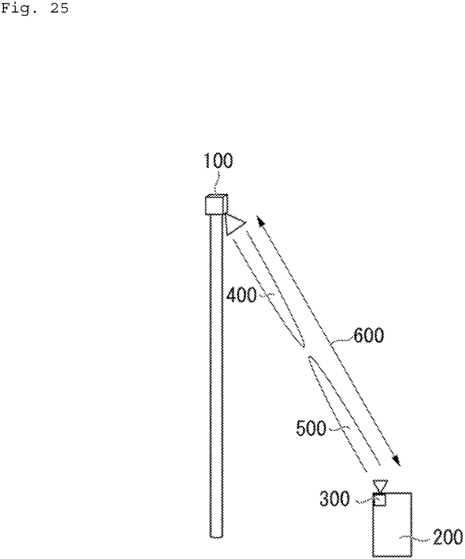

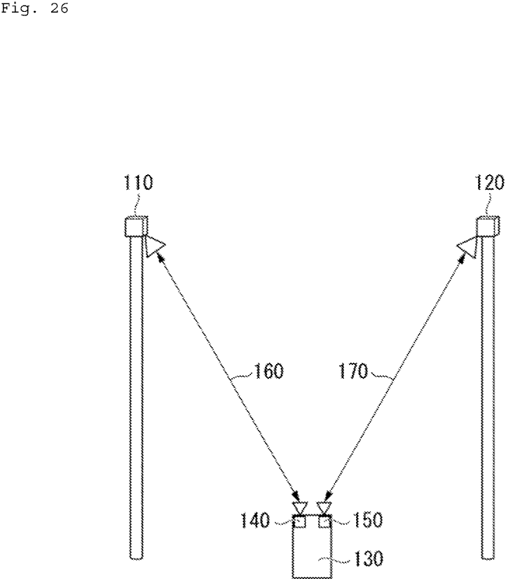

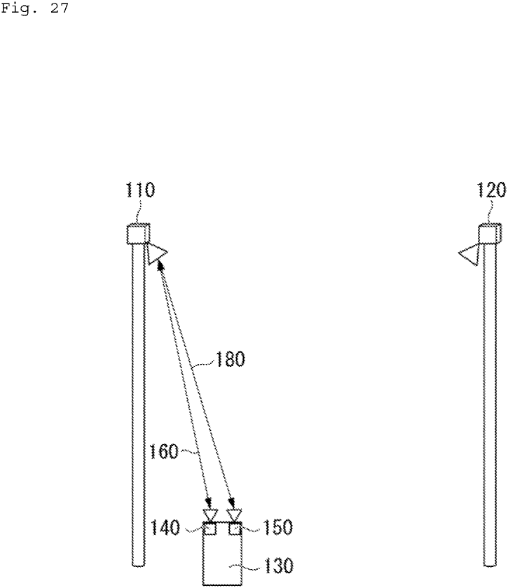

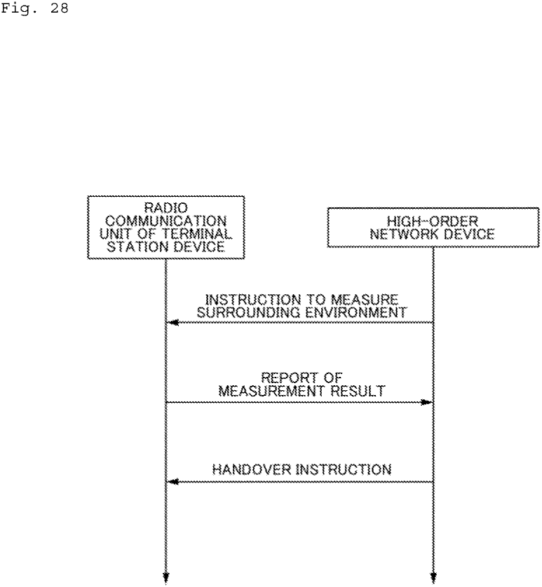

FIG. 24 is a diagram illustrating an example of a hardware configuration of the terminal station device 2 according to each embodiment. Some or all of the functional units of the terminal station device 2 are realized as software by causing a processor 210 such as a central processing unit (CPU) to execute a program stored in a storage device 211 or a memory 212 (a storage unit) including a nonvolatile recording medium (non-transitory recording medium). The program may be recorded on a computer-readable recording medium. The computer-readable recording medium is a non-transitory recording medium, for example, a portable medium such as a flexible disk, a magnetooptical disc, a read-only memory (ROM), or a compact disc read only memory (CD-ROM) or a storage device such as a hard disk embedded in a computer system. The communication unit 213 performs radio communication.

Some or all of the functional units of the terminal station device 2 may be realized using hardware including an electronic circuit or circuitry in which a large scale integration circuit (LSI), an application specific integrated circuit (ASIC), a programmable logic device (PLD), a field programmable gate array (FPGA), or the like is used.

Although the embodiments of the present invention have been described in detail with reference to the drawings, specific configurations are not limited to these embodiments, and designs and the like within the scope of the present invention without departing from the gist of the present invention are also included.

### INDUSTRIAL APPLICABILITY

The present invention is applicable to a communication system.

Reference Signs List
1 Radio communication system
2 Terminal station device
3 Base station device
20 Control unit
21 Radio communication unit
100 Base station device
110 Base station device
120 Base station device
130 Terminal station device
140 Radio communication unit
150 Radio communication unit
160 Communication link
170 Communication link
180 Communication link
200 Terminal station device
210 Processor
211 Storage device
212 Memory
213 Communication unit
300 Radio communication unit
400 Directional beam
500 Directional beam
600 Communication link

1. A radio communication method performed by a terminal station device, the method comprising:
a first radio communication step of establishing connection to a first base station device among a plurality of surrounding base station devices;
a control step of recording information regarding the first base station device on a storage unit as first connection destination information; and
a second radio communication step of establishing connection to a second base station device different from the first base station device with regard to the first connection destination information among the plurality of base station devices.

2. (canceled)

3. (canceled)

4. A terminal station device comprising:
a first radio communication unit connected to a first base station device among a plurality of surrounding base station devices;
a control unit configured to record information regarding the first base station device on a storage unit as first connection destination information; and
a second radio communication unit connected to a second base station device different from the first base station device with regard to the first connection destination information among the plurality of base station devices.

5. (canceled)

6. (canceled)
